(19) United States
(12) Patent Application Publication
(10) Pub. No.: US 2009/0047999 A1
(43) Pub. Date: Feb. 19, 2009

(54) Method and system for beamforming communication in wireless communication systems

(75) Inventors: Pengfei Xia, Mountain View, CA (US); Huaning Niu, Sunnyvale, CA (US); Chiu Ngo, San Francisco, CA (US)

Correspondence Address: Kenneth L. Sherman, Esq.;Myers Dawes Andras & Sherman, LLP, 19900 MacArthur Blvd., 11th Floor, Irvine, CA, 92612, US

(73) Assignee: Samsung Electronics Co., Ltd., Suwon City (KR)

(21) Appl. No.: 11/893,473

(22) Filed: Aug. 16, 2007

(51) Int. Cl. H04B 1/38; H04B 1/02; H04B 17/02

(52) U.S. Cl. 455/562.1; 455/101; 455/137

(57) ABSTRACT

A method and system for beamforming communication in a wireless communication system that includes a wireless initiator and a wireless responder is provided. A communication channel matrix is estimated at the responder based on training symbols from the initiator. The estimated channel matrix is then deconstructed into certain components, and the matrix components are quantized for feedback to the initiator for channel matrix reconstruction and beamforming communication.

### FIELD OF THE INVENTION

The present invention relates to beamforming in wireless communication systems, and in particular to beamforming in multiple-input-multiple-output (MIMO) wireless communication systems.

### BACKGROUND OF THE INVENTION

In a MIMO wireless communication system including a wireless transmitter and a wireless receiver, the availability of accurate communication channel state information at the transmitter allows higher throughput. Transmit beamforming uses the channel information for determining beamforming coefficients (beamforming/steering vectors) to properly steer the transmission beams for achieving higher throughput. To calculate the beamforming vector for a specific receiver, the transmitter requires an accurate estimate of the communication channel.

There are generally two approaches for acquiring information for estimating a channel from the transmitter to the receiver. One approach involves implicit feedback, while another approach involves explicit feedback. With implicit feedback, the transmitter (or initiator) receives a sounding packet from the receiver (or responder) and estimates the channel state information using channel reciprocity. Generally, channel reciprocity requires calibrated radio frequency (RF) chains in MIMO systems and further requires that the forward/reverse communication links operate in a time division duplex (TDD) mode.

With explicit feedback, the responder makes a direct estimate of the channel, e.g., using training symbols sent to the responder from the initiator. The responder then feeds back channel information based on the channel estimate, to the initiator. The initiator then computes the beamforming/steering vectors using the channel estimate returned by the responder. Existing implementations for explicit feedback of an uncompressed steering matrix require large feedback overhead of 2×Nr×N×Nb bits, where Nr is the number of receive antennas, N is the number of transmit antennas, and Nb is the number of bits representing each real number (normally it takes up to Nb=12 bits to represent a real number). In other implementations, each channel matrix is encoded using 3+2×Nb×N×Nr bits. However, this also leads to large transmission overhead for explicit channel information feedback.

### BRIEF SUMMARY OF THE INVENTION

The present invention provides a method and system for beamforming in communication in wireless communication systems. One embodiment involves beamforming by explicit channel feedback using quantization of the channel matrix. The wireless communication system includes an initiator (transmitter) and a responder (receiver). An example of said wireless communication system is a MIMO communication system, such as MIMO OFDM (orthogonal frequency division multiplexing), including a transmitter and a receiver.

In one implementation, the channel matrix is estimated at the responder based on training symbols from an initiator. The estimated channel is then deconstructed into components, and then the components are quantized for feedback to the initiator for beamforming communication.

The channel matrix is then reconstructed at the initiator using the received quantized matrix components. A beamforming matrix is then obtained based on the so-reconstructed channel matrix to steer transmission data in the spatial domain for beamforming communication.

In another implementation, the channel matrix is deconstructed column-by-column and quantized in a column-by-column (column-wise) at the responder. The quantized channel matrix is fed back to the initiator. The channel matrix is then reconstructed at the initiator by aligning columns in the proper order at the transmitter side. The beamforming matrix is then obtained from the so-reconstructed channel matrix.

In yet another implementation, the channel matrix is deconstructed row-by-row and quantized in a row-by-row manner (row-wise), at the responder. The channel matrix is then reconstructed at the initiator by aligning rows in the proper order at the transmitter side. The beamforming matrix is then obtained based on the so-reconstructed channel matrix.

These and other features, aspects and advantages of the present invention will become understood with reference to the following description, appended claims and accompanying figures.

### BRIEF DESCRIPTION OF THE DRAWINGS

FIG. 1 shows an example functional block diagram of a wireless MIMO communication system including a transmitter and a receiver that implement explicit feedback transmit beamforming by quantizing the channel matrix, according to an embodiment of the present invention.

FIG. 2 shows a functional block diagram for a transmitter in the communication system of FIG. 1, according to an embodiment of the present invention.

FIG. 3 shows a functional block diagram for a receiver in the communication system of FIG. 1, according to an embodiment of the present invention.

FIG. 4 shows a flowchart of the steps of an embodiment of the method of explicit feedback beamforming implemented in the example MIMO system in FIG. 1, according to an embodiment of the present invention.

FIG. 5 shows a functional block diagram of a wireless MIMO OFDM (orthogonal frequency division multiplexing) communication system including a transmitter and a receiver that implement explicit feedback transmit beamforming by quantizing the channel matrix on top of each subcarrier, according to an embodiment of the present invention.

In the drawings, like references, refer to similar elements.

### DETAILED DESCRIPTION OF THE INVENTION

The present invention provides a method and system for explicit feedback transmit beamforming in wireless communication systems. One embodiment involves explicit feedback transmit beamforming for a wireless communication system by quantization of the channel matrix. An example of the wireless communication system is a MIMO communication system including an initiator (transmitter or transmitting station) and a responder (receiver or receiving station), wherein the initiator transmitter includes multiple antennas, while the receiver may include one or more antennas. Explicit feedback transmit involves explicit feedback transmit beamforming by quantization of the channel matrix.

The initiator uses an estimate of the communication channel to calculate an appropriate set of steering vectors for transmit spatial processing when beamforming to a specific responder. Using explicit feedback, that responder makes a direct estimate of the channel from training symbols sent to the responder from the initiator. The responder quantizes the resulting channel estimate and sends it back to the initiator, wherein the initiator then computes the steering vectors using the quantized channel estimate.

Specifically, the channel matrix is deconstructed (sliced) at the responder and then quantized in a column-by-column manner using vector quantization for each column. The quantized channel matrix is then fed back to the initiator. At the initiator, the channel matrix is reconstructed by aligning columns in correct order. A beamforming matrix is then obtained based on the so-reconstructed channel matrix and used as the beamformer to steer transmission data in the spatial domain.

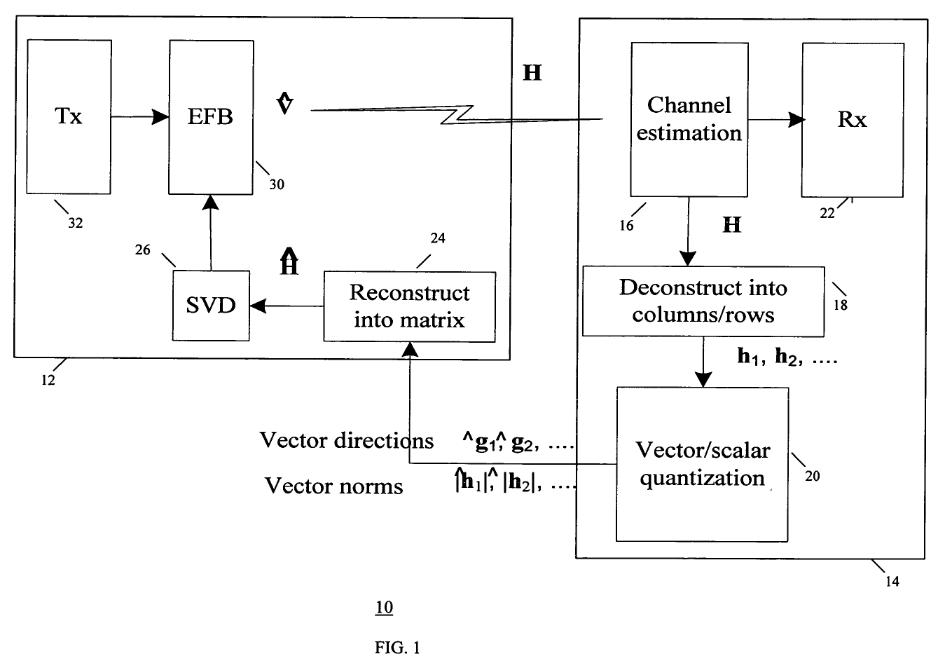

FIG. 1 shows an example functional block diagram of a wireless MIMO communication system 10 including an initiator 12 and a responder 14 that implement explicit feedback beamforming by quantizing the channel matrix, according to an embodiment of the present invention. In the responder 14, the channel matrix H is estimated by an estimator 16. The estimated channel matrix H is deconstructed in a column-by-column (column-wise) manner into columns (h₁, h₂, . . . ) by a matrix deconstructer 18 and then quantized by a quantizer 20 into vector directions and vector norms.

After channel estimation by the estimator 16, the channel matrix H is deconstructed by the deconstructer 18 into N columns hᵢ (i=1, . . . , N), as:

H=[h_{1,}h_{2, . . . ,}h_{N}]

Each column hᵢ can be expressed as:

hᵢ=|hᵢ|·g_{i,}
wherein |hᵢ| is the channel norm representing strength of the channel hᵢ, and |gᵢ|is the normalized version representing direction of the channel hᵢ.

The quantizer 20 performs vector/scalar quantization on the columns h₁, h₂, . . . , h_{N}, wherein for each column hᵢ, the channel strength and the channel direction are quantized separately. The channel strength is quantized using scalar quantization and the channel direction is quantized using vector quantization.

For quantizing the channel directions, a certain codebook Ω is required. The codebook Ω includes a group of candidate beamforming vectors wᵢ as:

Ω={w₁, . . . ,w_{K}},

wherein K is the codebook size for vector quantization, and every wᵢ is a candidate beamforming vector of dimension N×1 (N is the number of channel matrix components as a result of deconstruction). Systematic construction of a codebook of beamforming vectors is described further below.

For quantizing the channel strength, a known standard scalar quantization technique can be used, as described below.

The quantized channel matrix is fed back to the initiator 12 and reconstructed into a channel matrix Ĥ=[ĥ₁,ĥ₂, . . . ,ĥ_{N}] by a reconstructer (combiner) 24. The reconstructed channel matrix is processed by a Singular Value Decomposition (SVD) function 26, wherein an SVD operation decomposes the correlated MIMO channel into multiple parallel orthogonal pipes.

In operation, a transmit function (Tx) 32 in the initiator 12 transmits a signal to the responder 14, which is processed by a receive function (Rx) 22, as follows. Considering the MIMO system transmitting Nₛₛ number of data streams with N transmit antennas and Nᵣ receive antennas, then the received signal y at the receiver function 22 can be represented by relation (1) below:

y=HVx+n (1)

wherein x represents the Nₛₛ×1 transmitted signal vector, V represents the N×Nₛₛ transmit beamforming matrix/vector, H represents a Nᵣ×N channel response, and n represents a Nᵣ×1 additive noise vector in the channel. The transmitted signal x is provided by the transmit function 32.

An explicit feedback beamforming (EFB) module 30 in the initiator 12 multiplies the transmitted signal x by the beamforming matrix V and the resulting signal is sent to the transmit antennas. The explicit feedback transmit beamforming in FIG. 1 is based on quantizing the channel in a column-by-column manner using vector quantization, instead of conventional quantization of each matrix entry one by one.

A frame structure is used for data transmission between the initiator and the responder. For example, frame aggregation in a Media Access Control (MAC) layer and a physical (PHY) layer is implemented. In the initiator, a MAC layer attaches a MAC header to a MAC Service Data Unit (MSDU in order to construct a MAC Protocol Data Unit (MPDU). The MAC header includes information such as source addresses (SA) and a destination address (DA). The MPDU is a part of a PHY Service Data Unit (PSDU) and is transferred to a PHY layer in the initiator to attach a PHY header (i.e., PHY preamble) thereto to construct a PHY Protocol Data Unit (PPDU). The PHY header includes parameters for determining a transmission scheme including a coding/modulation scheme. Before transmission as a packet from a transmitter to a responder, a preamble is attached to the PPDU, wherein the preamble can include channel estimation and synchronization information.

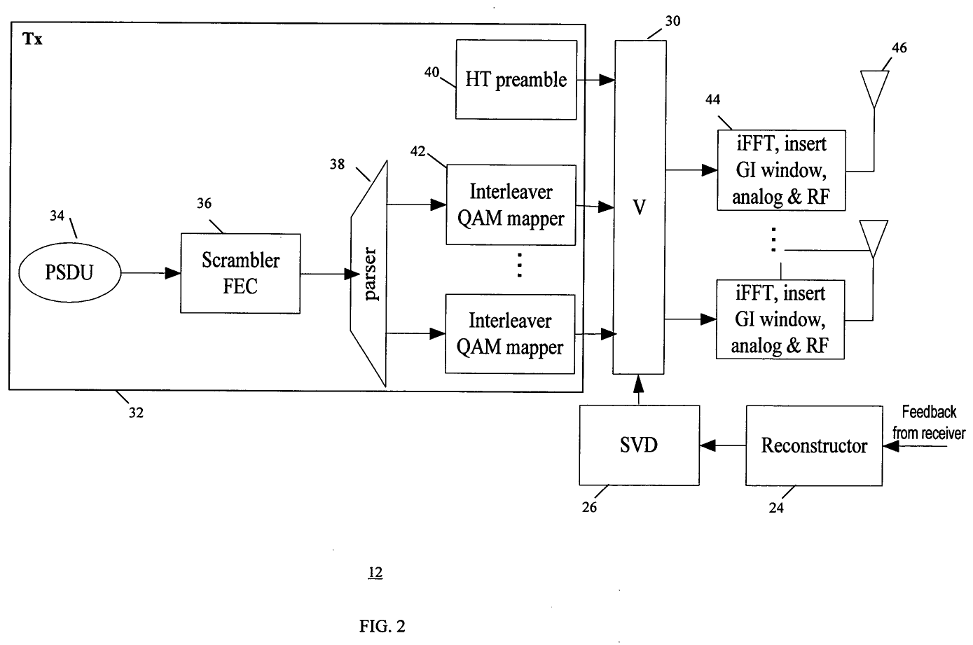

FIG. 2 shows a more detailed functional block diagram of the MIMO initiator 12. The Tx function 32 of the initiator 12 comprises a physical service data unit (PSDU) 34, a scrambler/forward error correction (FEC) function 36, a parser 38, a high throughput (HT) preamble insertion function 40, and multiple interleaver quadrature amplitude modulation (QAM) mapper modules 42. The initiator 12 further includes an transmit beamforming function (V function) 30, multiple inverse fast fourier transform (FFT) processors followed by analog RF chains 44, and multiple (N) transmit antennas 46.

Data to be transmitted is collected by the PSDU function 34 to generate PSDUs. The scrambler and forward error correction (FEC) encoder 36 are applied sequentially to randomize the PSDUs and to add encoding for protection against channel errors, respectively. The parser 38 distributes the randomized and encoded data into multiple streams so that the data streams can be processed in parallel by multiple processing paths.

In each processing path, the interleaver function of each module 42 shuffles the data to provide better channel error protection. The QAM mapper function of each module 42 modulates the binary data into symbols that can be transmitted. The HT preamble function 40 inserts an HT preamble for every PSDU so that the receiver can synchronize with the transmitter in frequency/time and can estimate the channel H. The explicit feedback transmit beamforming function 30 steers the transmitted signal to increase reception quality at the receiver. An inverse FFT/guard interval (GI) insertion/windowing function 44 completes the modulation (e.g., OFDM) at the initiator 12.

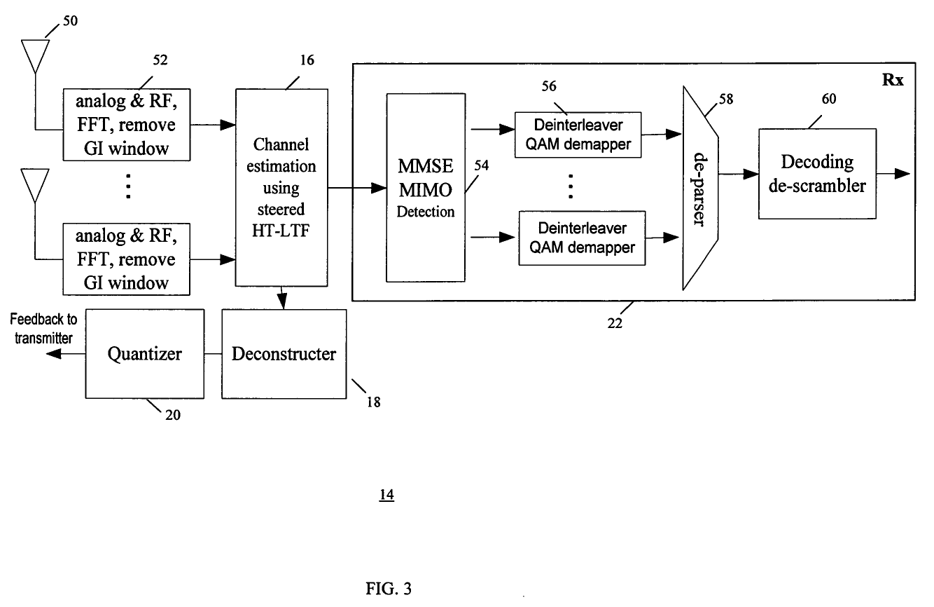

FIG. 3 shows a more detailed functional block diagram of the MIMO responder 14. The responder 14 includes said channel estimator 16, said matrix deconstructer 18, said quantizer 20, multiple (Nᵣ) receive antennas 50 and multiple stream processors 52. The Rx function 22 further includes a minimum mean square error (MMSE) MIMO detector 54, multiple deinterleaver QAM demappers 56, a deparser 58 and a decoding descrambler 60. After the analog RF chain, the FFT/GI removal/windowing function 52 of each processing stream completes the modulation (e.g., OFDM) at the receiver. The MMSE MIMO detector 54 detects the transmitted symbols. The deinterleaver 56 reshuffles the data back into their original order and the QAM demapper 56 performs the inverse operation of the QAM mapper 42. The deparser 58 multiplexes the multiple streams into a single stream. The decoding and descrambling function 60 inverts the function of the scrambling/FEC encoding function 36 of the receiver.

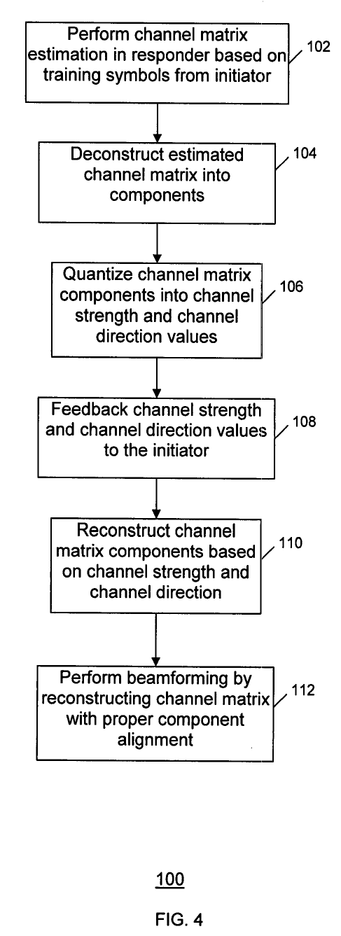

FIG. 4 shows a flowchart of a process 100 for explicit feedback beamforming for a wireless MIMO communication system such as the example MIMO system 10 in FIG. 1, according to an embodiment of the present invention. The beamforming process 100 includes the steps of:
Step 102: Channel matrix estimation at the responder. The channel matrix is estimated by the estimator 16 of the responder 14 based on training symbols from the initiator 12.
Step 104: Deconstruction of the channel matrix. The estimated channel matrix H is naturally deconstructed into components, e.g., N columns.
Step 106: Quantization of the channel matrix components. For each column hᵢ of the deconstructed channel matrix, the channel strength and the channel direction are quantized separately by the quantizer 20 of the responder 14. For the channel direction vector g, the quantizer 20 chooses the closest codeword from the codebook Ω such that a certain distortion metric is minimized. One example is provided below (although other performance metrics can also be used), as quantized channel direction:

$${w}_{opt} = \text{arg} {min}_{{w}_{i} ∈ Ω} ( 1 - {\vert {w}_{i}^{H} g \vert}^{2} ) .$$

Further, the quantizer 20 quantizes the channel strength |h|using standard scalar quantization techniques.
Step 108: Feedback channel information to the initiator. The quantized channel direction and strength (i.e., decision bits for the channel direction and for the channel strength) are then fed back separately to the initiator 12.
Step 110: Reconstruction of the channel matrix. Each channel matrix column is reconstructed at the initiator by the reconstructer 24 based on the quantized channel strength and quantized channel direction. For example, for the i^{th} column, if the quantized channel strength is |ĥᵢ| and the quantized channel direction is w_{opt,} then the i^{th} channel matrix column can be reconstructed as:

ĥᵢ=|ĥᵢ|wₒₚₜ.
The channel matrix is then reconstructed by the reconstructer 24 by aligning all columns in the correct order as:

Ĥ=[ĥ₁,ĥ₂, . . . ,ĥ_{N}].
Step 112: Beamforming. Singular value decomposition of the reconstructed channel matrix is then performed by the SVD 26, yielding:

Ĥ=ÛŜ\hat{V}^{H}
wherein Û,\hat{V} are unitary matrices and Ŝ is a diagonal matrix containing the singular values. The unitary matrix \hat{V} is then used as the beamforming vector by the EFB 30 to steer data from Tx 32 in the spatial domain.

Using a column-by-column (i.e., column-wise) quantization approach according to said embodiment of the present invention, the total number of feedback bits required is:

(N_{q}+log₂(K))·N,

wherein N is the number of transmit antennas, K is the codebook size for vector quantization, and N_{q} is the number of bits to quantize channel strength of every column of the channel matrix H. Compared with the conventional requirement of 2×N r×N×Nb feedback bits (needed to provide accurate/perfect CSI to the initiator), a substantial reduction of feedback is achieved according to the present invention. A reduction ratio of (N_{q}+log₂K)/(2×Nr×Nb) in terms of number of feedback bits is thus achieved. Note that if Nr is small and if N_{q} and Nb are comparable, the reduction ratio can be approximated as 1/(2×Nr), assuming that log₂K<<2×Nr×Nb.

Using such a column-by-column (i.e., column-wise) quantization approach, the responder complexity is only on the order of 4×Nr×N, while a storage for the codebook Ω on the order of 2×K×N is needed. More importantly, such a column-wise quantization approach leads to simpler codebook designs based on the generic vector quantization algorithm, as is detailed below.

An example of constructing the codebook Ω is now described. A systematic algorithm, known as the generalized Lloyd algorithm, is utilized in generating the codebook Ω, where each component of Ω is a beamforming vector of dimension N×1. It is assumed that the channel statistics are known, and can be captured by a random process S.
Step A: Randomly choose a very large collection of channel realizations, H, from the random channel process S. Normally, the total number of realizations in H is on the order of 10⁵ or higher.
Step B: Initialize Ω with any valid codebook. A codebook is valid if every column wᵢ is normalized, i.e., ∥wᵢ∥=1 for all i=1, . . . , K.
Step C: For the new/updated codebook and every channel realization hᵣ in H apply the following rule to update the channel space partition:

hᵣεRᵢ if and only if d(h,wᵢ)≦d(h,wⱼ)∀j≠i.
Region Rᵢ can be called the neighborhood of codeword wᵢ, while codeword wᵢ is often referred to as the representative (or, head) of region Rᵢ. A certain channel realization hᵣ joins region Rᵢ, if and only if, representative wᵢ turns out to be the closest one among all possible representatives w₁, w₂, . . . , w_{K}. Note that each channel realization can be assigned to only one region, and has to be assigned to one region as well. The channel space partition is completed once all channel realizations have been successfully assigned to a certain region.
Step D: For the updated space channel partition in step C, compute the local channel correlation matrix for each region as:

Rᵢ=(1/nᵢ)Σhᵣhᵣ^{H} if hᵣεRᵢ, ∀i=1, . . . ,K,
wherein nᵢ is the number of channel realizations that fall into region Rᵢ.
Step E: For the new local channel correlation matrix in step D, update every region representative wᵢ with the principal eigenvector of the local channel correlation matrix Rᵢ, i.e., the eigenvector of Rᵢcorresponding to the largest eigenvalue.
Step F: Repeat steps C through E until the codebook Ω converges.

As such, the present invention provides efficient feedback, simplified codebook design, less receiver complexity, and reduced codebook storage requirement at both the initiator 12 and the responder 14. Further though the initiator includes multiple antennas, the responder may include one or more antennas. Though the responder is shown in the drawings as having multiple antennas, the present invention is also applicable to a single antenna responder.

The channel matrix can also be deconstructed at the responder in a row-by-row fashion into Nr rows f₁, f₂, . . . , f_{Nr} and then quantized in a row-by-row manner (row-wise), by performing vector quantization for each row. Specifically, for each row, the channel strength and the channel direction are quantized separately. The channel strength is quantized using scalar quantization and the channel direction is quantized using vector quantization. The strength of each row vector is quantized using scalar quantization. The quantized channel matrix is then fed back to the initiator. At the initiator, the channel matrix is reconstructed by aligning rows in the proper order. A beamforming matrix is then obtained based on the so-reconstructed channel matrix.

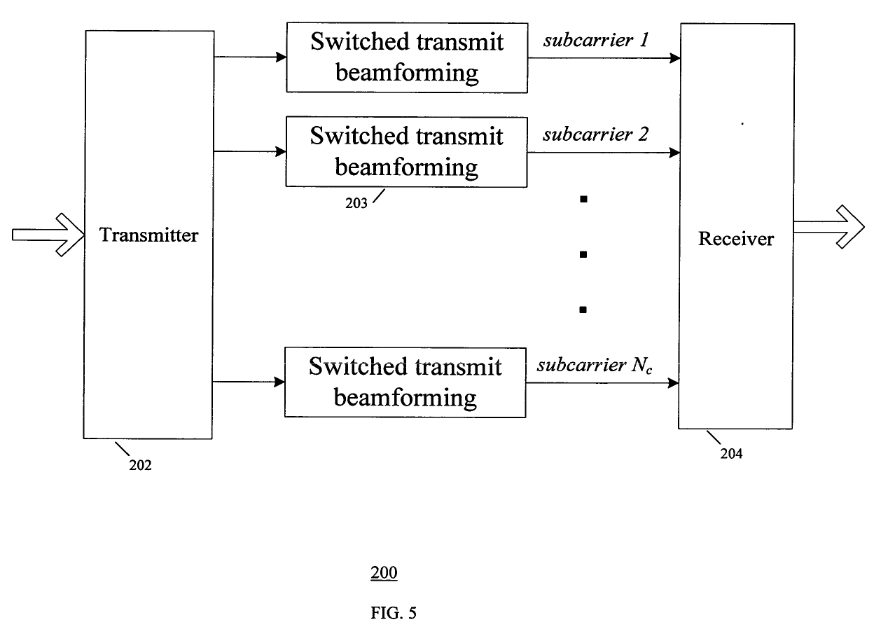

Explicit feedback beamforming according to the present invention can be applied to plain MIMO wireless communication systems as well as MIMO OFDM wireless communication systems. For MIMO OFDM systems, the explicit feedback beamforming method is applied separately for different sub-carriers. FIG. 5 shows a functional block diagram of a wireless MIMO OFDM communication system 200 including a transmitter 202 (initiator) and a receiver 204 (responder) that implement channel estimation via explicit channel feedback transmit beamforming by quantizing the channel matrix, according to an embodiment of the present invention. The example in FIG. 5 illustrates that multiple (N_{C}) orthogonal subcarriers (subcarrier 1, . . . , subcarrier N_{C}) are formed through switched transmit beamforming 203 for each subcarrier, using inverse FFT, cyclic prefix insertion at the transmitter and FFT, and cyclic prefix removal at the receiver.

Compared with the conventional direct matrix quantization approaches, a component-wise (e.g., column-wise or row-wise) quantization approach according to the present invention provides less receiver complexity and reduced codebook storage requirement. More importantly, such a column-wise quantization approach leads to simpler codebook designs based on the generic vector quantization algorithm. Quantizing the channel matrix in a component-wise manner at the receiver/responder, and then reconstructing the channel matrix at the transmitter via a limited amount of feedback, enables simplified codebook design, less receiver complexity, and reduced codebook storage requirement at both the transmitter and receiver sides.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method for beamforming in a wireless communication system including a wireless initiator and a wireless responder, comprising:
estimating a communication channel matrix at a responder based on training symbols from an initiator;
deconstructing the estimated channel matrix into certain components; and
quantizing the channel matrix components for feedback to the initiator for channel matrix reconstruction and beamforming communication.

2. The method of claim 1 further comprising:
feeding back the quantized channel matrix components from the responder to the initiator; and
reconstructing the channel matrix at the initiator using the quantized channel matrix components.

3. The method of claim 2 further comprising:
transmit beamforming based on the reconstructed quantized channel matrix.

4. The method of claim 1 wherein quantizing the channel matrix components further includes quantizing the channel strength and the channel direction for each matrix component.

5. The method of claim 4 wherein quantizing the channel matrix components further includes quantizing the channel strength for each matrix component separately from quantizing the channel direction for that matrix component.

6. The method of claim 5 wherein quantizing the channel matrix components further includes quantizing the channel strength for each matrix component by scalar quantization.

7. The method of claim 6 wherein quantizing the channel matrix components further includes quantizing the channel direction for each matrix component by vector quantization.

8. The method of claim 2 wherein reconstructing the channel matrix further includes reconstructing the channel matrix by aligning matrix components in the proper order.

9. The method of claim 2 further including generating a beamforming matrix as a singular matrix of the reconstructed channel matrix.

10. The method of claim 9 wherein the wireless communication system comprises a MIMO wireless communication system, the method further including transmit beamforming based on the beamforming matrix.

11. The method of claim 2 wherein:
deconstructing the estimated channel matrix includes deconstructing the estimated channel matrix column-by-column into multiple columns; and
reconstructing the channel matrix includes reconstructing the channel matrix from the quantized channel matrix columns.

12. The method of claim 11 wherein:
deconstructing the estimated channel matrix into columns further includes deconstructing the estimated channel matrix H column-by-column into N columns h₁, h₂, . . . , h_{N}, and
reconstructing the channel matrix from the quantized channel matrix columns includes reconstructing the channel matrix as Ĥ=[ĥ₁,ĥ₂, . . . ,ĥ_{N}].

13. The method of claim 12 wherein each column hᵢ of the deconstructed estimated channel matrix H is represented as:
hᵢ=|hᵢ|·g_{i,} i=1, . . . , N,
wherein |hᵢ|is the channel norm representing strength of the channel hᵢ, and gᵢ is the normalized version representing direction of the channel hᵢ.

14. The method of claim 13 further including quantizing the channel directions using a certain codebook Ω including of a group of candidate beamforming vectors wᵢ as:
Ω=}w₁, . . . ,w_{K}},
wherein K is the codebook size for vector quantization, and every wᵢ is a candidate beamforming vector of dimension N×1.

15. The method of claim 14 wherein quantizing the channel directions further includes quantizing a channel direction vector gby choosing the closest codeword from codebook Ω such that a certain distortion metric is minimized.

16. The method of claim 15 wherein quantizing the channel directions further includes quantizing the channel direction vector g by choosing the closest codeword from codebook Ω such that the distortion metric is minimized as:
$${w}_{opt} = \text{arg} {min}_{{w}_{i} ∈ Ω} ( 1 - {\vert {w}_{i}^{H} g \vert}^{2} ) .$$

17. The method of claim 13 further including quantizing the channel strength |h| by scalar quantization.

18. The method of claim 17 wherein reconstructing the channel matrix further includes: for the i^{th} column, if the quantized channel strength is |ĥᵢ|and the quantized channel direction is wₒₚₜ then reconstructing the i^{th} channel matrix as:
ĥᵢ=|ĥᵢ|wₒₚₜ.

19. The method of claim 18 wherein reconstructing the channel matrix further includes aligning all columns in the correct order to obtain a reconstructed channel matrix as:
Ĥ=[ĥ₁,ĥ₂, . . . ,ĥ_{N}].

20. The method of claim 19 wherein transmit beamforming further includes obtaining singular value decomposition of the reconstructed channel matrix as:
Ĥ=ÛŜ\hat{V}^{H}
wherein Û,\hat{V} are unitary matrices and Ŝ is a diagonal matrix containing the singular values.

21. The method of claim 20 wherein transmit beamforming further includes using the unitary matrix \hat{V} as the beamformer to steer transmit data from the initiator in the spatial domain.

22. The method of claim 21 wherein:
deconstructing the estimated channel matrix includes deconstructing the estimated channel matrix row-by-row into multiple rows; and
reconstructing the channel matrix includes reconstructing the channel matrix from the quantized channel matrix rows.

23. The method of claim 22 wherein desconstructing the estimated channel matrix into rows further includes deconstructing the estimated channel matrix H row-by-row into Nr rows f₁, f₂, . . . , f_{Nr}.

24. The method of claim 23 wherein reconstructing the channel matrix from the quantized channel matrix rows includes reconstructing channel matrix as:
Ĥ=[f₁^{H} f₂^{H} . . . f_{Nr}^{H}]^{H}.

25. The method of claim 24 wherein each row fᵢ of the deconstructed estimated channel matrix H is represented as:
fᵢ=|fᵢ|·eᵢ, i=1, . . . , Nr,
wherein |fᵢ| is the channel norm representing strength of the channel fᵢ, and eᵢ is the normalized version representing direction of the channel fᵢ.

26. The method of claim 25 further including quantizing the channel directions using a certain codebook Ω including a group of candidate beamforming vectors wᵢ as:
Ω={w₁, . . . ,w_{K}},
wherein K is the codebook size for vector quantization, and every wᵢ is a candidate beamforming vector of dimension Nᵣ×1.

27. The method of claim 26 wherein quantizing the channel directions further includes quantizing the channel direction vector e by choosing the closest codeword from codebook Ω such that a certain distortion metric is minimized.

28. The method of claim 27 wherein quantizing the channel directions further includes quantizing the channel direction vector e by choosing the closest codeword from codebook Ω such that distortion metric: is minimized as:
$${w}_{opt} = \text{arg} {min}_{{w}_{i} ∈ Ω} ( 1 - {\vert {w}_{i}^{H} e \vert}^{2} ) .$$

29. The method of claim 25 further including quantizing the channel strength |f| by scalar quantization.

30. The method of claim 29 wherein reconstructing the channel matrix further includes: for the ith row, if the quantized channel strength is |\hat{f}ᵢ| and the quantized channel direction is wₒₚₜ, then reconstructing the ith channel matrix as:
\hat{f}ᵢ=|\hat{f}ᵢ|wₒₚₜ.

31. The method of claim 30 wherein reconstructing the channel matrix further includes aligning all rows in the correct order to obtain a reconstructed channel matrix as:
Ĥ=[\hat{f}₁^{H} \hat{f}₂^{H} . . . \hat{f}_{Nr}^{H}]^{H}.

32. The method of claim 31 wherein transmit beamforming further includes obtaining singular value decomposition of the reconstructed channel matrix as:
Ĥ=ÛŜ\hat{V}^{H},
wherein Û,\hat{V} are unitary matrices and Ŝ is a diagonal matrix containing the singular values.

33. The method of claim 32 wherein transmit beamforming further includes using the unitary matrix \hat{V} as the beamformer to steer transmit data from the initiator in the spatial domain.

34. A wireless receiver for beamforming communication, comprising:
an estimator configured for estimating a communication channel matrix based on received training symbols from a wireless transmitter;
a deconstructor configured for deconstructing the estimated channel matrix into certain components; and
a quantizer configured for quantizing the channel matrix components for feedback to the wireless transmitter for channel matrix reconstruction and beamforming communication.

35. The receiver of claim 34 wherein the quantizer is further configured for quantizing the channel strength and the channel direction for each matrix component.

36. The receiver of claim 35 wherein the quantizer is further configured for quantizing the channel strength for each matrix component separately from quantizing the channel direction for that matrix component.

37. The receiver of claim 36 wherein the quantizer is further configured for quantizing the channel strength for each matrix component by scalar quantization.

38. The receiver of claim 37 wherein the quantizer is further configured for quantizing the channel direction for each matrix component by vector quantization.

39. The receiver of claim 34 wherein the wireless receiver comprises a MIMO wireless receiver.

40. The receiver of claim 34 wherein the deconstructor is further configured for deconstructing the estimated channel matrix column-by-column into multiple columns.

41. The receiver of claim 34 wherein the deconstructor is further configured for deconstructing the estimated channel matrix row-by-row into multiple rows.

42. A wireless transmitter for beamforming communication, comprising:
a reconstructor configured for reconstructing a channel matrix using quantized channel matrix components from a wireless receiver; and
a beamformer configured for determining a beamforming vector based on the reconstructed quantized channel matrix for beamforming communication.

43. The transmitter of claim 42 wherein the beamformer is further configured for steering transmit data in the spatial domain.

44. The transmitter of claim 42 wherein the beamformer is further configured for transmit beamforming based on the reconstructed quantized channel matrix.

45. The transmitter of claim 42 wherein the receiver estimates a communication channel matrix based on received training symbols from the transmitter, deconstructs the estimated channel matrix into certain components, quantizes the channel matrix components for feedback to the transmitter.

46. The transmitter of claim 42 wherein the reconstructor is further configured for reconstructing the channel matrix by aligning matrix components in the proper order.

47. The transmitter of claim 42 wherein the beamformer includes a singular value decomposition module configured for generating a beamforming matrix as a singular matrix of the reconstructed quantized channel matrix.

48. The transmitter of claim 42 wherein the reconstructor is further configured for reconstructing the quantized channel matrix from quantized channel matrix columns.

49. The transmitter of claim 42 wherein the reconstructor is further configured for reconstructing the quantized channel matrix from the quantized channel matrix rows.
